(19) United States
(12) Patent Application Publication
(10) Pub. No.: US 2019/0092106 A1
(43) Pub. Date: Mar. 28, 2019

(54) SYSTEM FOR MONITORING VEHICLE WHEEL ASSEMBLY PARAMETERS

(71) Applicant: GM Global Technology Operations LLC, Detroit, MI (US)

(72) Inventors: Amin Abdossalami, Toronto (CA); Joseph K. Moore, Whitby (CA)

(21) Appl. No.: 15/715,790

(22) Filed: Sep. 26, 2017

(51) Int. Cl. B60C 23/06; B60C 23/04; B60C 19/00; G01M 1/14; H01H 35/14

(52) U.S. Cl. CPC B60C 23/061; B60C 23/065; B60C 23/0415; B60C 2019/004; G01M 1/14; H01H 35/144; B60C 19/003

(57) ABSTRACT

A system for monitoring parameters of a vehicle wheel assembly includes a wheel speed sensor configured to produce a wheel speed signal, and a wheel assembly monitoring module operatively connected to the wheel speed sensor. The wheel assembly monitoring module determines a dynamic response of the wheel speed signal at one or more wheel speeds. A wheel assembly health module provides one of a visual output, an audible output, and a haptic output indicating that the wheel assembly has exceeded a selected wheel assembly parameter threshold based on the dynamic response of the wheel speed signal.

### INTRODUCTION

The subject disclosure relates to the art of vehicles and, more particularly, to a system for monitoring vehicle wheel parameters.

Vehicles include wheels that support tires. The tires provide an interface between vehicle drive components and a road surface. Manufacturers endeavor to ensure that tires possess desired geometric properties. However, manufacturing tolerances may allow a tire to be out of balance. That is, a tire may not be truly symmetrical about a center axis. Likewise, manufacturing tolerance may allow a wheel to be out of balance. Thus, once a tire is installed on a wheel, a technician typically balances the tire/wheel assembly. In most cases, a dynamic balancing system is employed so as to more closely mimic operating conditions.

Over time, tires may become worn due to interaction with the road surface. Similarly, wheels may experience geometric changes due to interactions with road surface irregularities or other objects. Tire wear and geometric changes in one or more wheels may result in an out of balance condition which, at certain speeds, may trigger undesirable vibrations. Vibrations induced by imbalance can propagate to chassis components such as bearings and bushings, that could form part of a suspension system and/or a steering system, causing excessive wear and degradation that may lead to premature failure. Accordingly, it is desirable to provide a system that is designed to identify wheel and/or tire irregularities before vibrations may develop.

### SUMMARY

In accordance with an exemplary embodiment, a system for monitoring parameters a wheel assembly for a vehicle includes a wheel speed sensor configured to produce a wheel speed signal, and a wheel assembly monitoring module operatively connected to the wheel speed sensor. The wheel assembly monitoring module determines a dynamic response of the wheel speed signal at one or more wheel speeds. A wheel assembly health module provides one of a visual output, an audible output, and a haptic output indicating that the wheel assembly has exceeded a selected wheel assembly parameter threshold based on the dynamic response of the wheel speed signal.

In addition to one or more of the features described above or below, or as an alternative, further embodiments could include an inertial measurement unit (IMU) configured to produce an inertial signal indicating an inertia of the vehicle.

In addition to one or more of the features described above or below, or as an alternative, further embodiments could include wherein the wheel assembly monitoring module is operatively connected to the IMU, the wheel assembly monitoring module determining a dynamic response of the inertial signal.

In addition to one or more of the features described above or below, or as an alternative, further embodiments could include wherein the wheel assembly health module provides the one of the audible output, the visual output, and the haptic output indicating that the wheel assembly has exceeded the selected wheel assembly parameter threshold based on the dynamic response of the wheel speed signal and the dynamic response of the inertial signal.

In addition to one or more of the features described above or below, or as an alternative, further embodiments could include wherein the wheel assembly health module determines a location on a vehicle of a wheel assembly that has exceeded the selected wheel assembly threshold.

In addition to one or more of the features described above or below, or as an alternative, further embodiments could include wherein the selected wheel assembly parameter threshold defines a mass imbalance condition.

In addition to one or more of the features described above or below, or as an alternative, further embodiments could include wherein the wheel assembly health module determines a relative position on the wheel assembly of the mass imbalance condition.

In addition to one or more of the features described above or below, or as an alternative, further embodiments could include wherein the wheel assembly health module determines a magnitude of the mass imbalance condition.

In addition to one or more of the features described above or below, or as an alternative, further embodiments could include wherein the selected wheel assembly parameter threshold defines one of a geometric imbalance condition, a structural imbalance condition and a force imbalance condition.

In accordance with another aspect of an exemplary embodiment, a vehicle includes a body defining, in part, an occupant compartment, one or more wheel assemblies rotatably supported relative to the body, and a system for monitoring vehicle wheel assembly parameters of the one or more wheel assemblies. The system includes a wheel speed sensor configured to produce a wheel speed signal, and a wheel assembly monitoring module operatively connected to the wheel speed sensor. The wheel assembly monitoring module determines a dynamic response of the wheel speed signal at one or more wheel speeds. A wheel assembly health module provides one of a visual output, an audible output and a haptic output indicating that the wheel assembly has exceeded a selected wheel assembly parameter threshold based on the dynamic response of the wheel speed signal.

In addition to one or more of the features described above or below, or as an alternative, further embodiments could include an inertial measurement unit (IMU) configured to produce an inertial signal indicating an inertia of the vehicle.

In addition to one or more of the features described above or below, or as an alternative, further embodiments could include wherein the wheel assembly monitoring module is operatively connected to the IMU, the wheel assembly monitoring module determining a dynamic response of the inertial signal.

In addition to one or more of the features described above or below, or as an alternative, further embodiments could include wherein the wheel assembly health module provides the one of the audible output, the visual output, and the haptic output indicating that the wheel assembly has exceeded the selected wheel assembly parameter threshold based on the dynamic response of the wheel speed signal and the dynamic response of the inertial signal.

In addition to one or more of the features described above or below, or as an alternative, further embodiments could include wherein the wheel assembly health module determines a location on a vehicle of a wheel assembly that has exceeded the selected wheel assembly threshold.

In addition to one or more of the features described above or below, or as an alternative, further embodiments could include wherein the selected wheel assembly parameter threshold defines a mass imbalance condition.

In addition to one or more of the features described above or below, or as an alternative, further embodiments could include wherein the wheel assembly health module determines a relative position on the wheel assembly of the mass imbalance condition.

In addition to one or more of the features described above or below, or as an alternative, further embodiments could include wherein the wheel assembly health module determines a magnitude of the mass imbalance condition.

In addition to one or more of the features described above or below, or as an alternative, further embodiments could include wherein the selected wheel assembly parameter threshold defines one of a geometric imbalance condition, a structural imbalance condition and a force imbalance condition.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including a system for monitoring wheel assembly parameters, in accordance with an exemplary embodiment;

FIG. 2 is a block diagram illustrating a wheel assembly monitoring system, in accordance with an aspect of an exemplary embodiment; and

FIG. 3 is a flow chart illustrating a method of monitoring wheel assembly parameters, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

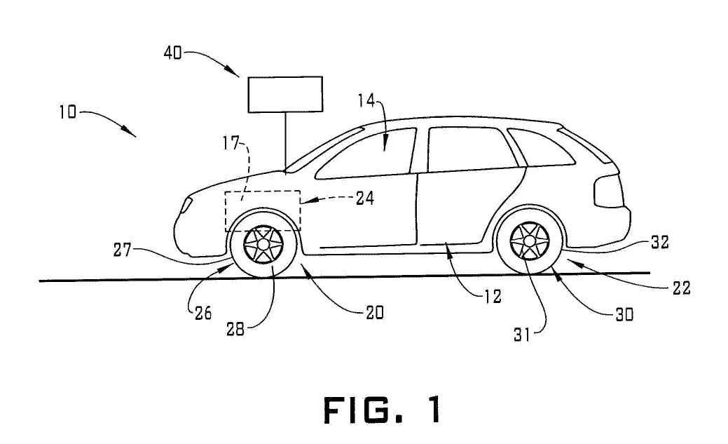

A vehicle, in accordance with an aspect of an exemplary embodiment, is indicated generally at 10 in FIG. 1. Vehicle 10 includes a body 12 that defines, in part, an occupant compartment 14. Vehicle 10 also includes a prime mover 17 that is operatively connected to a front wheel system 20 and a rear wheel system 22 through a transmission 24. It is to be understood that prime mover 17 may take on a variety of forms including internal combustion engines, electric motors and hybrid power systems. It should also be understood that vehicle 10 may be configured as a front wheel drive vehicle, a rear wheel drive vehicle or an all-wheel drive vehicle.

Front wheel system 20 includes first and second front wheel assemblies, one if which is indicated at 26. Each front wheel assembly 26 includes a front wheel 27 that supports a front tire 28. Similarly, rear wheel system 22 includes first and second rear wheel assemblies, one of which is indicated at 30. Each rear wheel assembly 30 includes a rear wheel 31 that supports a rear tire 32. It should be understood that each front wheel assembly 26 is readily interchangeable with each rear wheel assembly 30 and vice versa.

In accordance with an aspect of an exemplary embodiment, vehicle 10 includes a wheel assembly monitoring system 40 that monitors parameters associated with each front wheel assembly 26 and rear wheel assembly 30. Parameters associated with each wheel assembly may include a geometric non-uniformity. The term “geometric non-uniformity” should be understood to describe geometric, structural, or force variations.

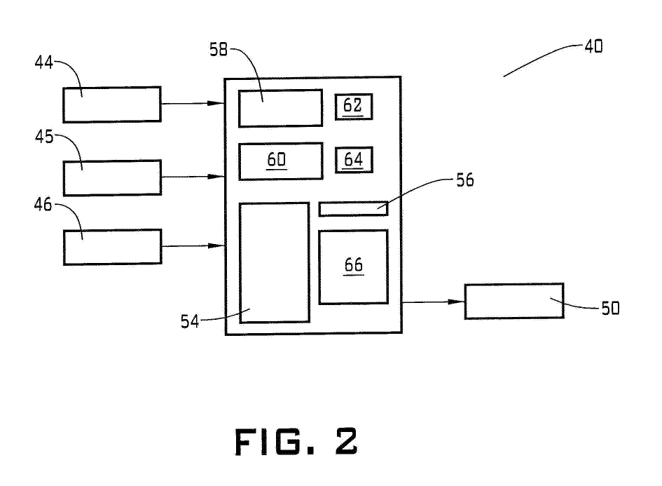

As seen in FIG. 2, and with continued reference to FIG. 1, wheel assembly monitoring system 40 is operatively connected to a plurality of wheel speed sensors 44. Each of the plurality of wheel speed sensors 44 is associated with monitoring a speed of each front wheel assembly of front wheel system 20 and each rear wheel assembly of rear wheel system 22. Wheel assembly monitoring system 40 may also include a plurality of damper sensors 45 and an inertia sensor 46. Damper sensors 45 are associated with each suspension dampener (not shown) on vehicle 10. Suspension dampeners may include Macpherson struts, shock absorbers and the like. Inertia sensor 46 may detect changes in inertia of vehicle 10 that may be associated with various driving maneuvers.

Wheel assembly monitoring system 40 receives inputs from each wheel speed sensor 44, damper sensor 45 and inertia sensor 46 and determines a “state of health” of each wheel assembly of front wheel system 20 and each wheel assembly of rear wheel system 22, and provides an alert 50 through, for example, an interface in vehicle 10. The alert may take the form of a visual alert, an audible alert and a haptic alert. The state of health may include a geometric non-uniformity.

Wheel assembly monitoring system 40 also includes a central processor unit (CPU) 54 operatively connected to a non-volatile memory module 56 having stored thereon a set of program instructions that will be described herein. Wheel assembly monitoring system 40 also includes a road roughness module 58, a damper health module 60, a road condition module 62, a vehicle acceleration module 64 and a wheel assembly health module 66.

Road roughness module 58 may be coupled to damper sensors 45 and/or inertia sensor 46 to determine a roughness metric of a road surface. Damper health module 60 is operatively connected to damper sensor 45 and determines parameters associated with wear of vehicle dampers. Road condition module 62 may be operatively connected to wheel speed sensors 44. Road condition module 62 may determine whether a road surface is slippery based on inputs from wheel speed sensors 44. Vehicle acceleration module 64 may be connected to inertia sensor 46 and determine whether vehicle 10 is experiencing accelerations above a selected threshold. The accelerations may indicated that vehicle 10 is maneuvering aggressively.

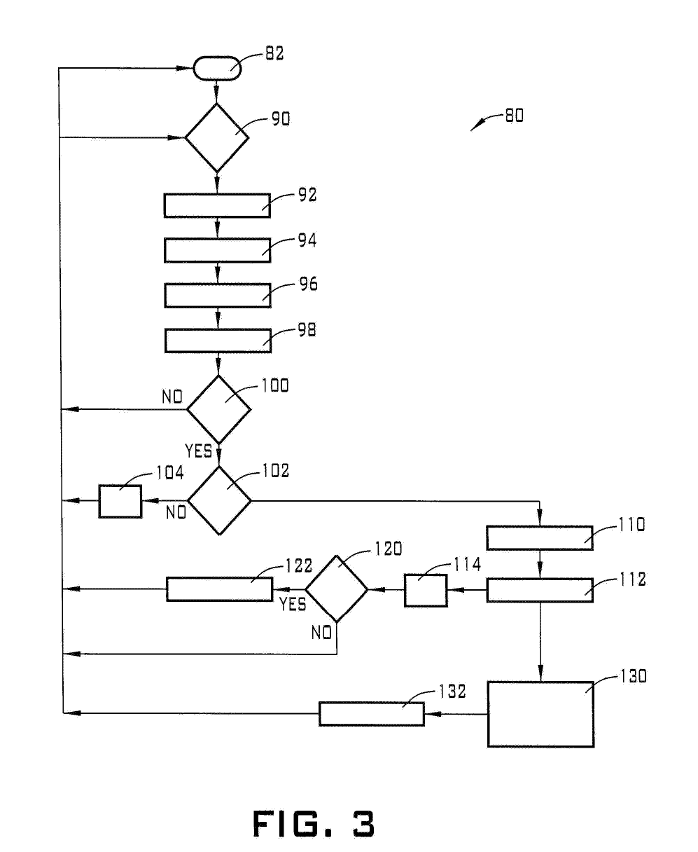

Wheel assembly health module 66 evaluates signals from road roughness module 58, damper health module 60, road condition module 62 and vehicle acceleration module 64 to evaluate wheel assembly parameters according to the program instructions stored in non-volatile memory module 56. Reference will now follow to FIG. 3, with continued reference to FIGS. 1 and 2 in describing a method 80 of monitoring wheel assembly parameters in accordance with an exemplary embodiment.

Method 80 begins in block 82. In block 90, a determination is made whether one or more enabling criteria are met. Enabling criteria may include whether a road surface meets a selected roughness criteria; whether the road surface meets a selected road slip condition criteria; whether vehicle dampers meet a selected health criteria; and/or if vehicle 10 is maneuvering below a selected aggressiveness criteria. If all of the enabling criteria are met, wheel assembly monitoring system 40 determines a rotation frequency of each vehicle wheel based on a wheel speed signal from wheel sensors 44 in block 92.

In block 94, a time window of the wheel speed signal is established. The duration of the time window may vary. For example, the time window may be one minute or the time window could represent the time required for one full wheel rotation. In block 96, wheel assembly monitoring system 40 tracks mathematical orders of wheel acceleration based on wheel rotation frequency. In block 98, wheel assembly monitoring system 40 builds an array of order tracked wheel speed sensor data for each wheel of vehicle 10. Wheel assembly monitoring system 40 also determines an order tracked inertial measurement unit (IMU) from inertia sensor 46.

In one embodiment, the order tracked wheel speed may represent a correlation of a wheel speed signal with a sinusoid function that has a frequency identical to integer multiples of rotation frequency of that wheel, and the order tracked inertial measurement unit may represent a correlation of an inertial measurement signal with the sinusoid function that has a frequency identical to integer multiples of rotation frequencies of the wheel(s). In another embodiment, the order tracked wheel speed may represent a correlation of a wheel speed signal with a complex exponential function (Fourier basis) that has a frequency identical to integer multiples of rotation frequency of the wheel, and the order tracked inertial measurement unit may represent a correlation of an inertial measurement signal with the complex exponential function (Fourier basis) that has a frequency identical to integer multiples of rotation frequencies of the wheel(s). In yet another embodiment, order tracked wheel speed sensor data may represent a power spectral density of a wheel speed sensor signal at the frequency of wheel rotation, and the order tracked inertial measurement unit may represent a spectral density of inertial measurement signal at integer multiples of the frequencies of wheel rotation(s).

In block 100, wheel assembly monitoring system 40 determines whether order tracked wheel speed exceeds a pre-determined threshold. If the pre-determined order tracked wheel speed threshold is not exceeded, method 80 returns to block 82. If the pre-determined wheel speed threshold is exceeded for one or more vehicle wheels, then that wheel will be included in a list of suspect wheels. A suspect wheel represents a wheel or tire that has either geometric non-uniformity and/or a mass imbalance. A determination is made in block 102 whether tracked IMU order is greater than a pre-determined threshold. If the threshold in block 102 is not exceeded, a determination is made in block 104, that a geometric non-uniformity exists in an associated one of the vehicle suspect wheel(s). At this point, an alert may be presented to a driver and/or maintenance person regarding geometric non-uniformity in the suspect wheel(s).

An imbalance force at each wheel transmitted to the spindle can be written as a phasor as follows

Fᵢ=mᵢωᵢ²e^{(ω}^{ᵢ}^{t+θ}^{ᵢ}⁾ (Eq. 1)

where mᵢ is the combined mass and distance of the imbalance mass from center of the wheel i. The variable ωᵢ represents the speed of wheel i. The parameter θᵢ denotes the phase or angular location of the wheel speed signal in a polar reference frame that is fixed or in sync w.r.t. the IMU signal inside selected time window. It can be derived for each wheel by comparing the IMU signal and the wheel speed signal. (alternatively, we can say, phase of the wheel speed signal relative to the IMU signal).

The contribution of mass imbalance in all wheels to the measured signal at IMU sensor can be derived as follows where N is the number of wheels:

IMU=Σᵢ₌₁^{N}FᵢGᵢ(ωᵢ)+ [symbol] =Σᵢ₌₁^{N}mᵢωᵢ²e^{(ω}^{ᵢ}^{t+θ}^{ᵢ}⁾Gᵢ(ωᵢ)+ [symbol] (Eq. 2)

where the transfer function from each wheel imbalance force to the IMU, Gᵢ(ω), is known and can be obtained by attaching a known mass to a wheel and measuring the IMU response as well as wheel speed phasor at different speed levels or bins. [symbol] represents noise factors such as measurement noise and other sources of vibrations that contribute to IMU measured signal. In order to minimize the impact of intervening noise factors such as nonlinear vertical dynamics the longitudinal and lateral IMU signal can be used.

If the thresholds in block 102 are exceeded, in one embodiment, an array of cross correlation magnitudes between each wheel speed signal and IMU signal is constructed for a selected period of time and for a selected number of speed levels in block 110 until there is sufficient variation in the collected θᵢ(s). In block 112, an average cross-correlation magnitude for each wheel speed and IMU is determined at plurality of speed levels and over extended period of time, to represent a mass imbalance mᵢ for each suspect vehicle wheel.

In another embodiment, in block 112 a combined mass and distance of the imbalance mᵢ can be derived using a regression method or an adaptive filter such as recursive least squares. In another embodiment, in block 112 if there a separation in measured wheel speed signals exceeds a selected parameter, ωᵢ(s) then the imbalance parameters mᵢ(s) can be derived by directly correlating the IMU signal with each wheel speed signal.

In block 114, if the imbalance parameter mᵢ derived in block 112 for each wheel is greater than a pre-determined threshold at corresponding speed, then a mass imbalance is determined for that suspect wheel. If it is determined that a wheel absolute rotational orientation is measured for each suspect wheel in block 120 then a relative angular position of the mass imbalance in the polar reference frame of the suspect wheel may be determined in block 122 using wheel speed phasor, IMU phasor, and transfer function Gᵢ (ω) phasor at that particular speed bin. At this point, the existence of and a position of the mass imbalance may be communicated to a user or maintenance person through alert 50 via a vehicle interface.

In block 130, mass imbalance magnitude mᵢ may be subtracted from the order tracked wheel speed sensor signal and, in block 132, a determination is made whether a geometric non-uniformity exists in a suspect wheel assembly after removing the impact of mass imbalance. If the pre-determined order tracked wheel speed threshold is exceeded, a geometric non-uniformity is determined to exist in an associated one of the vehicle suspect wheel(s). At this point an alert may be presented to a driver and/or maintenance person regarding geometric non-uniformity in the suspect wheel(s).

It should be appreciated that the exemplary embodiments provide a system for identifying, in real time, a wheel parameter that may exceed a desired threshold and alert a user or maintenance person.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A system for monitoring parameters of a wheel assembly for a vehicle comprising:
a wheel speed sensor configured to produce a wheel speed signal;
a wheel assembly monitoring module operatively connected to the wheel speed sensor, the wheel assembly monitoring module determining a dynamic response of the wheel speed signal at one or more wheel speeds; and
a wheel assembly health module providing one of a visual output, an audible output, and a haptic output indicating that the wheel assembly has exceeded one of a selected wheel assembly geometric non-uniformity parameter threshold and a selected wheel assembly imbalance parameter threshold based on the dynamic response of the wheel speed signal.

2. The system according to claim 1, further comprising an inertial measurement unit (IMU) configured to produce an inertial signal indicating an inertia of the vehicle.

3. The system according to claim 2, wherein the wheel assembly monitoring module is operatively connected to the IMU, the wheel assembly monitoring module determining a dynamic response of the inertial signal.

4. The system according to claim 3, wherein the wheel assembly health module provides the one of the audible output, the visual output, and the haptic output indicating that the wheel assembly has exceeded the one of the one of a selected wheel assembly geometric non-uniformity parameter threshold and a selected wheel assembly imbalance parameter threshold based on the dynamic response of the wheel speed signal and the dynamic response of the inertial signal.

5. The system according to claim 1, wherein the wheel assembly health module determines a location on a vehicle of a wheel assembly that has exceeded the one of the one of a selected wheel assembly geometric non-uniformity parameter threshold and a selected wheel assembly imbalance parameter threshold.

6. The system according to claim 1, wherein the selected wheel assembly imbalance parameter threshold defines a mass imbalance condition.

7. The system according to claim 6, wherein the wheel assembly health module determines a relative position on the wheel assembly of the mass imbalance condition.

8. The system according to claim 6, wherein the wheel assembly health module determines a magnitude of the mass imbalance condition.

9. The system according to claim 1, wherein the selected wheel assembly parameter threshold defines one of a geometric imbalance condition, a structural imbalance condition and a force imbalance condition.

10. A vehicle comprising:
a body defining, in part, an occupant compartment;
one or more wheel assemblies rotatably supported relative to the body; and
a system for monitoring vehicle wheel assembly parameters of the one or more wheel assemblies, the system comprising:
a wheel speed sensor configured to produce a wheel speed signal;
a wheel assembly monitoring module operatively connected to the wheel speed sensor, the wheel assembly monitoring module determining a dynamic response of the wheel speed signal at one or more wheel speeds; and
a wheel assembly health module providing one of a visual output, an audible output and a haptic output indicating that the wheel assembly has exceeded one of a selected wheel assembly geometric non-uniformity parameter threshold and a selected wheel assembly imbalance parameter threshold based on the dynamic response of the wheel speed signal.

11. The vehicle according to claim 10, further comprising an inertial measurement unit (IMU) configured to produce an inertial signal indicating an inertia of the vehicle.

12. The vehicle according claim 11, wherein the wheel assembly monitoring module is operatively connected to the IMU, the wheel assembly monitoring module determining a dynamic response of the inertial signal.

13. The vehicle according claim 12, wherein the wheel assembly health module provides the one of the audible output, the visual output, and the haptic output indicating that the wheel assembly has exceeded the one of the selected wheel assembly geometric non-uniformity parameter threshold and the selected wheel assembly imbalance parameter threshold based on the dynamic response of the wheel speed signal and the dynamic response of the inertial signal.

14. The vehicle according to claim 10, wherein the wheel assembly health module determines a location on a vehicle of a wheel assembly that has exceeded the one of the selected wheel assembly geometric non-uniformity parameter threshold and the selected wheel assembly imbalance parameter threshold.

15. The vehicle according to claim 10, wherein the selected wheel assembly imbalance parameter threshold defines a mass imbalance condition.

16. The vehicle according to claim 15, wherein the wheel assembly health module determines a relative position on the wheel assembly of the mass imbalance condition.

17. The vehicle according to claim 15, wherein the wheel assembly health module determines a magnitude of the mass imbalance condition.

18. The vehicle according to claim 10, wherein the selected wheel assembly parameter threshold defines one of a geometric imbalance condition, a structural imbalance condition and a force imbalance condition.
